(19) United States
(12) Patent Application Publication
(10) Pub. No.: US 2003/0046133 A1
(43) Pub. Date: Mar. 6, 2003

(54) System and method of optimizing carrier selection

(76) Inventors: Eric Ronald Morley, St. Paul, MN (US); Christopher Aronovici, Brooklyn Park, MN (US)

Correspondence Address: Stephanie J. Smith, Beck and Tysver, P.L.L.C., 2900 Thomas Avenue S., Suite 100, Minneapolis, MN, 55416, US

(21) Appl. No.: 09/942,364

(22) Filed: Aug. 29, 2001

(51) Int. Cl. G06F 17/60

(52) U.S. Cl. 705/8

(57) ABSTRACT

A carrier selection system and method assesses carriers based on lane-specific factors, such as carrier performance on the lane and carrier capacity to serve the lane.

### FIELD OF THE INVENTION

The present invention relates generally to a system and method to select a carrier to move a product shipment from one location to another. More particularly, the invention relates to a system and method to select a carrier taking into account various route- or lane-specific factors, such as the carrier's past performance on a given lane, and the capacity of the carrier available on the lane on the day needed.

### BACKGROUND OF THE INVENTION

It is common practice for an organization that needs goods transported from one location to another to engage one or more trucking carriers. Typically this practice is called “for-hire” trucking. Shipments are often organized on an ad hoc or less-than-regular basis. Finding the most efficient and cost-effective carrier for a given shipment is a relatively difficult task, with a number of variables affecting performance and price playing a role.

Performance in the transportation industry is typically considered to include such characteristics as on-time performance, accuracy of delivery (i.e. goods picked up from and shipped to the correct location), and the amount or rate of claims for damaged goods. That is, some carriers can be more reliable than others by delivering their shipments on-time and to the right location more often than others and by keeping low the number of claims for damaged goods. Performance factors, such as these, may vary from carrier company to carrier company, but carriers may vary from one “lane” to another. “Lane” as used herein shall mean a trip from one location to another.

Carriers are inclined to charge heavily for shipments that go to remote locations where they are unlikely to engage a return load. Conversely, it is cost effective for a company to provide a return load for the carrier when possible. Thus, in some cases, overall efficiency can be increased by, for example, delaying a first lane by a day, such that a return load is available.

Further, trucks vary in size, and are best selected to “just fit” the size of the load; a half full truck will cost the same as a full truck. There are two main categories or modes of for-hire trucking: less-than-truckload (LTL) carriers and truckload (TL) carriers. LTL carriers typically pick up small shipments that are then sorted and combined with other shippers' freight and dispatched as a full truckload to another terminal, where individual shipments are further sorted for local delivery. Truckload carriers, on the other hand, typically move full loads from the shipper's location to a single destination. The mode on which a truck is operating affects scheduling and cost, and therefore is one of the variables to consider when selecting a carrier for a particular shipment.

Other variables play a role in transportation management. For a given lane on a particular day, one carrier might supply a team of drivers for a truck which can complete a trip in less time than a single driver, because a team does not have to take government-mandated rest stops. Typically, though, a carrier will provide teams for some lanes on some days, but not for others or not for the same lane on another day. Thus, driver type varies from one trip to the next.

Longer trips are more desireable to carriers, and are therefore priced more attractively.

For companies that require that goods be shipped from many locations to many other locations, the logistics of selecting cost-efficient, well-performing carriers for a given lane on a particular date is staggeringly intricate. This is complicated, in many cases, by agreements between companies and carriers which demand a certain minimum number of lanes from a carrier over a given period of time, and which specify a maximum number of lanes that a carrier will provide over that given period of time.

This is of particular concern for national retailers with multiple distribution centers and multiple stores throughout the country which select from more than one carrier, starting from multiple locations. The task of selecting, scheduling and routing carriers efficiently, while keeping costs down, is complex. What has been needed is an automated or semi-automated, or computer-aided, system and method for selecting carriers for each shipment such that shipping needs are met cost-effectively with satisfactory performance. Further, what has been needed is a system for making such a selection within the parameters defined by contracts with carriers for the minimum and maximum number of loads to be shipped during a given period.

### SUMMARY OF THE INVENTION

The system and method of the present invention selects a carrier from a group of carriers to transport goods from a first location to a second location, by comparing carriers to one another based on the carriers' ability to serve that particular lane.

According to another aspect of the invention, a system and method selects a carrier from a group of carriers to transport goods from a first location to a second location by rating each carrier's past performance on trips from the first location to the second location; evaluating each carrier's capacity for that lane; evaluating the cost for each carrier to make the trip; comparing the carriers; and selecting a carrier.

According to another aspect of the invention, a system and method selects a carrier from a group of carriers to transport a shipment of goods from a first location to a second location, by: determining the mode (truckload, less-than-truckload, or other) of each carrier; rating each carrier's past performance on trips from the first location to the second location; evaluating each carrier's capacity; evaluating the cost for each carrier to make the trip; comparing the carriers; and selecting a carrier.

According to another aspect of the invention, a system and method selects a carrier from a group of carriers to transport a shipment of goods from a first location to a second location, by: for each carrier, identifying the maximum number of shipments allowed to that carrier over a given period of time; comparing the number of shipments carried by each carrier during the given period to the maximum number allowed to that carrier; for each carrier that has not exceeded the allowed shipment number during said period, rating each carrier's past performance on trips from the first location to the second location, evaluating each carrier's capacity, evaluating the cost for each carrier to make the trip, comparing the carriers, selecting a carrier; and adjusting the capacity data for that carrier during the given period to reflect the load taken.

### BRIEF DESCRIPTION OF THE DRAWINGS

An exemplary version of a system and method is shown in the figures wherein like reference numerals refer to equivalent structure throughout, and wherein:

FIG. 1 is a schematic illustration of a multi-lane transportation grid for which the described system and method for transportation management can be used;

FIG. 2 is a flow chart illustrating a method for evaluating carriers based on performance, cost and capacity for a given lane; and

FIG. 3 is a a flow chart illustrating a method for evaluating carriers based on performance, cost, mode and capacity for a given lane.

### DETAILED DESCRIPTION OF PREFERRED EMBODIMENT(S)

This invention will be described below in the context of shipments of goods by trucking carriers under for-hire contracts with a retailer which has multiple distribution centers and multiple stores, and therefore multiple points of pickup and delivery. The system and method offer particular advantages in this context. It will be understood, however, by those of skill in the art of transportation management, that the system and method described can be employed to manage transportation needs in other contexts or applications as well. For example, the system and method can be used with other types of transportation, such as air and rail.

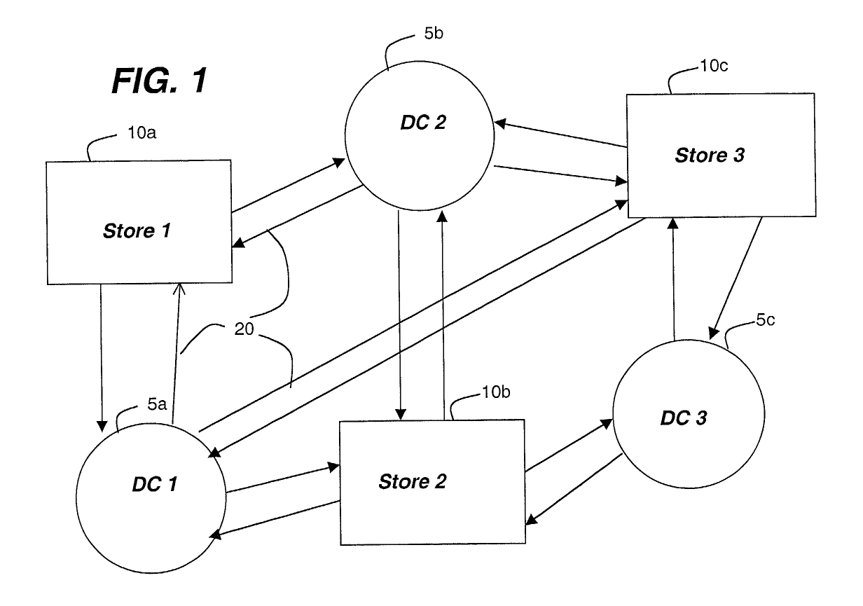

FIG. 1 illustrates schematically a simple example of a distribution system 1. The illustrated system 1 includes three distribution centers 5a, 5b, and 5c from which goods or a variety of goods are stored. As needed, goods are shipped from these distribution centers to retail stores, illustrated in FIG. 1 as 10a, 10b, and 10c. Goods might also be shipped from one distribution center to another distribution center, or from one store to another, or from a store to a distribution center, or from a distribution center or store back to a manufacturer or port (not illustrated). Further, any distribution center might ship to any store, regardless of proximity, though in most case, stores will receive goods from the nearest or most convenient distribution center. The nearest distribution is not necessarily the most convenient, due to road construction or road type.

A path from one location (“origin”) to another (“destination”) will be termed a “lane” herein. Each arrow in FIG. 1 illustrates a lane 20 to and from distribution centers and stores, but it will be understood that a lane is a path from any location in the grid to another, and only a few examplary lanes are represented by arrows in FIG. 1, and only a few of the illustrated arrows are designated with reference number 20. For purposes of this illustration, the goods are shipped via truck trailers over roads. A lane need not be over any particular road between two points, but rather represents any route that a driver might take between the two locations.

The preferred system and method for selecting a carrier does so on a lane basis; that is, it scores, assesses and ranks potential carriers based on lane-specific information. This is advantageous because factors determining the desirability of each carrier varies by lane. These factors include, for example, capacity, contractual arrangements, past-performance, mode of operation, driver type, cost, trip length and so forth.

The preferred system and method accommodates and takes into account the capacity requirements and limits of the carriers. In many cases, these capacity parameters are lane-specific. Capacity is affected by a number of factors. Contractual arrangements between carriers and their customers typically include provisions by which the customer promises to use a specified minimum number of trips in a given time period (often per day or per week), and the carrier promises to make available a maximum number of trucks per given time period. The system and method of the present invention track and accommodate these contractual arrangements. When a carrier is selected for, and takes a lane, the database is updated to reflect the lane taken, and the remaining capacity of that carrier is correspondingly reduced. For example, if a company commits to using three trailers in a day from a given carrier, the database stores the number 3 in association with that carrier and the time period. When the company books one trailer on that day, the database subtracts one from the commitment number, reflecting that two trailers must still be used on that day. Conversely, the database may have a field that stores the number of lanes taken by a carrier during a time period, and the system and method compares the number of lanes taken with the number committed to until the number of lanes taken is equal to the number committed to. Carriers that have “committed-to” routes available when the system is queried may receive preference over carriers with whom the minimum obligation has already been met. This preferential treatment can be accomplished through a scoring and ranking process.

When the contractually-specified time period for the measurement of minimum and maximum levels has passed, the system resets the carrier's capacity data. In other words, if a carrier contracts to carry a minimum number of three trailers in a day, the system begins the day with an allocation of three. When the carrier is used, that capacity number is reduced automatically. Regardless of the number of trailers used during that first day, on Day Two, the capacity for that carrier is re-set to three.

Similarly, volume restrictions, set by contract or policy, limit the number of loads that a customer will ship on a given carrier during a specified time period. This maximum can be lane-specific. The system and method track and use this maximum limit to disqualify or discount the score of a carrier that has met its specified maximum during the specified time period. At the end of the time period, the system automatically resets the load counter so that the carrier starts fresh at the beginning of the next time period.

Past performance on a specified lane is another factor used by the preferred system and method for selecting a carrier. Carrier performance may vary from one lane to another. For example, Carrier A might have a past-performance record which, on average, over all lanes, exceeds the past-performance record of Carrier B. However, on Lane A, Carrier B has a significantly better past-performance record and therefore is a better choice for Lane A. Therefore, significant advantages are achieved when a carrier's past performance on the lane in question is used to evaluate a carrier for a trip.

Another aspect of optimal efficient carrier selection involves the “mode” in which a truck or load operates. As described above, one such mode is “truckload” (“TL”) in which the truck is engaged entirely by one customer. Another mode is “less-than-truckload” (“LTL”) in which a truck carries shipments for more than one customer. An LTL will be cheaper for a customer, but it will generally take longer since the truck will be stopping to pick up and drop off the shipments of others along the way. The system and method of the present invention accommodates and accounts for trailers' modes by storing the mode in a database and using the mode in a scoring and ranking system to evaluate and compare carriers for a given lane.

The system and method of the present invention preferably use a relational database on a computer or computer network to store and process data regarding the carriers.

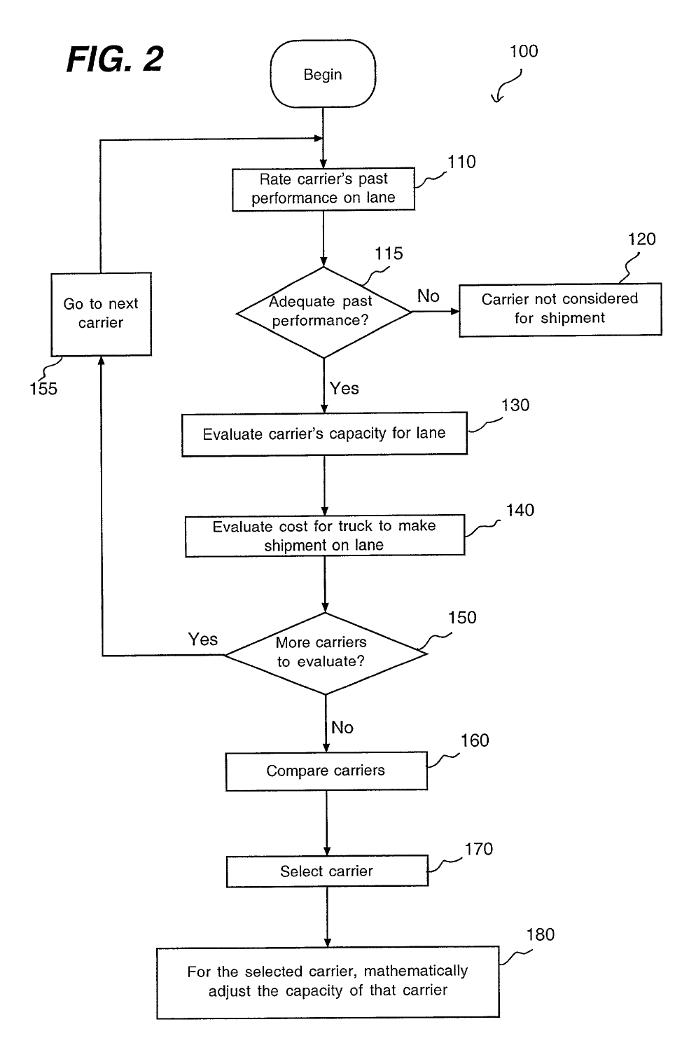

FIG. 2 illustrates a method (100) of evaluating carriers for a particular trip over a lane. In step 110, the carrier's past performance on the lane in question is evaluated or accessed. In one embodiment, performance evaluation software stores data such as on-time percentage, claims for damages and the like, applies a ranking process to yield an overall performance score which can then be used in the comparison of carriers. In the method illustrated in FIG. 2, the system evaluates whether or not the past performance of the carrier on the lane has been satisfactory (115). If the past performance has not been satisfactory, then the carrier is eliminated from consideration (120). Alternatively, a carrier with unsatisfactory performance can remain under consideration for the trip, but the scoring and ranking process will reflect the past sub-standard performance. In step 130, the system evaluates the carrier's capacity for the lane. As described above, the database stores the number of trips necessary to fulfill the customer's minimum under the terms of its contract with the carrier. The system determines whether the commitment to the carrier has been fulfilled and whether the maximum has been reached. According to the user's preference, those carriers for whom the minimum has not been reached can be given preferential treatment over carriers whose minimum has been reached.

In step 140, the cost for a trailer supplied by the carrier for the given lane is evaluated or calculated. The cost is typically a function of both rate and distance. Carriers often offer better rates for longer trips and for trips to locations where they can easily book a return trip.

All eligible carriers are evaluated (150, 155) and compared (160) for past performance on the lane, for their capacity for the lane during the relevant time period and for the cost to provide a trailer for a lane. A scoring and ranking process can be used to determine which carrier is best suited for the lane. Finally, a carrier is selected (170). The highest scoring carrier can be automatically selected and booked, or the system can provide for the user to make a selection based on the results returned by the system. Upon selection, a load order is planned, typically by the customer's load planner.

When a carrier has been selected, the system stores data (180) reflecting that that load has been taken, so that when the carrier is evaluated for the next haul, its capacity numbers reflect the previously-taken load. This data is used in conjunction with the minimum and maximums set by contract with the carrier for a lane. This can be accomplished in many ways. For example, the system can store the number of loads accepted on the lane, and when that number is equal to the minimum number of loads contracted for on that lane for that time period, the carrier is removed from consideration, or are scored and ranked to reflect that the contract requirement has been met. As another example, a capacity number, equal to the minimum contract requirement, is stored. Each time a load is accepted, the capacity number is reduced by one. In either event, or with the use of other equivalent mathematical system, the capacity data are re-set when a new contractual time period begins. Typically, this is daily or weekly. The time period may vary by carrier; the time period may vary for a carrier from time to time; and the time period may vary per lane.

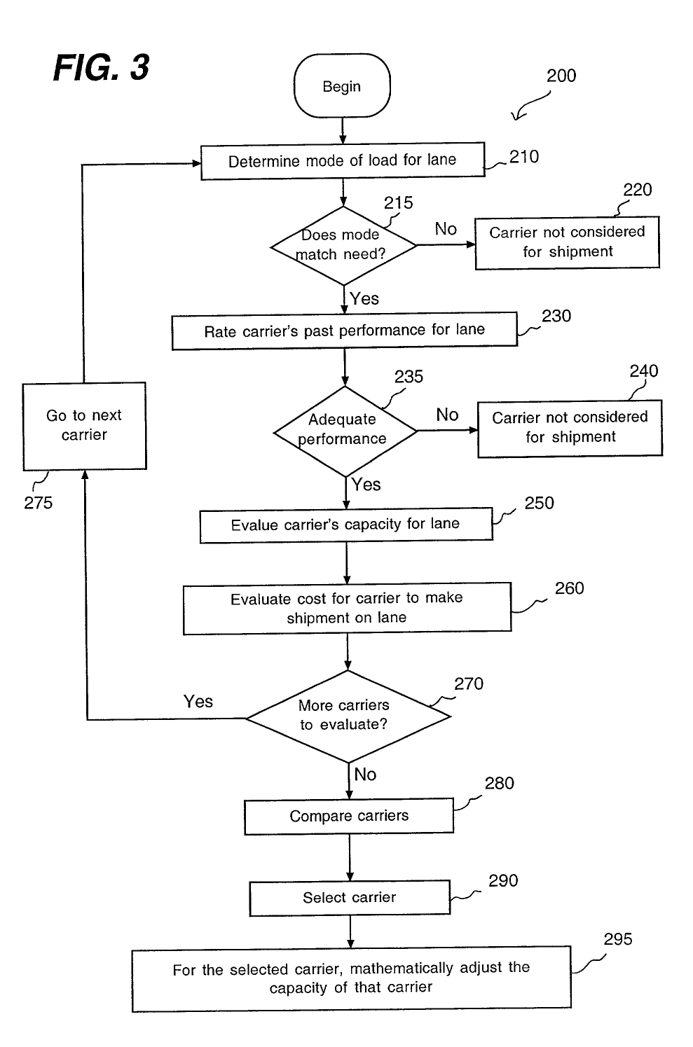

The process 100 can be performed automatically upon querying the database, and the evaluation of each carrier may be performed in parallel, rather than serially, as described above and illustrated, such as by steps 150, 155, in the Figures. Further, the order of evaluation (past performance, capacity, cost) can be varied or these factors can be evaluated simultaneously, rather than serially as described. If desired, additional factors can be evaluated and used in the process 100 that are not illustrated in FIG. 2, such as the type of driver (team versus single driver), the size and features of the truck that are required for the shipment, the length of the trip, the carrier's estimate for shipment time and start date. Additionally, the mode of the truck or load can be used in the evaluation process and this is described below with reference to FIG. 3. Still further, system-wide considerations can be incorporated into the evaluation process as described below to lower the costs of the transportation system as a whole.

FIG. 2 illustrates another preferred embodiment of a method 200 for evaluating and selecting a carrier for a shipment on a specified lane. This method 200 illustrates the use of mode, past-performance, capacity and cost in the evaluation of carriers. At least one of these factors is lane-specific, and preferably each of these factors is lane-specific. In step 210, the system review the mode of the trailers available through a carrier to determine whether the mode matches the needs of the customer for that trip on that lane. The mode review (215) can operate to disqualify (220) a carrier that does not offer the appropriate mode. Alternatively, the mode review (215) might simply affect the pricing for that carrier on that lane. In step 230, the system rates the carrier's past performance on the lane in question. The performance review (235) can operate to disqualify (240) a carrier that has not had satisfactory performance on the lane, as illustrated in FIG. 3. Alternatively, the performance review (235) simply affects the performance score, and ultimately the carrier's end score and its ranking versus other carriers.

In step 250, the carrier's capacity for the lane is evaluated, as described above in conjunction with FIG. 2, step 130. In step 260, the cost for the carrier to make the trip on the lane is evaluated, as described above with respect to FIG. 2.

Each eligible carrier is evaluated (270, 275), the carriers are compared to one another (280) using a scoring and ranking system and method, and the best-suited carrier is then selected (290) either automatically or manually.

When the carrier accepts a load, the capacity numbers are adjusted (295), as described above with respect to FIG. 1 and step 180.

The process 200 can be performed automatically upon querying the database, and the evaluation of each carrier may be performed in parallel, rather than serially, as described above and illustrated, such as by steps 270, 275, in FIG. 3. Further, the order of evaluation (mode, past performance, capacity, cost) can be varied or these factors can be evaluated simultaneously, rather than serially as described. If desired, additional factors can be evaluated and used in the process 200 that are not illustrated in FIG. 3, such as the type of driver (team versus single driver), the size and features of the truck that are required for the shipment, the length of the trip, the carrier's estimate for shipment time and start date. Preferably, these factors are evaluated on a lane-specific basis. Additionally, the mode of the truck can be used in the evaluation process and this is described below with reference to FIG. 3. Still further, system-wide considerations can be incorporated into the evaluation process as described below to lower the costs of the transportation system as a whole.

In a preferred embodiment, one or more computers are used to facilitate the system and method. Data relating to past performance, contract requirements and limits, carriers' rates and the like are stored in computer memory. Software running on the computer performs filtering, sorting, scoring and ranking processes using the stored data. Preferably, a carrier's capacity data is automatically adjusted by the system when a trip on a lane is booked with that carrier.

### System-Wide Optimization

The system and method incorporates into its evaluation, the systemic trucking needs of a user. For example, Carrier A is only able to carry one route on a given day. Carrier A is able to serve Lane A for $1.00. Carrier B can serve Lane A for $2.00. However, the user also needs service for Lane B, which Carrier A can serve for $1.00, while Carrier B is unavailable and Carrier C would cost $3.00. Therefore the system will determine that the user should select Carrier B for Lane A for $2.00 and use Carrier A for Lane B for $1.00, for a total cost of $3.00. Had the user selected Carrier A for Lane A, it's total cost for the two lanes would be $4.00.

Further, the combining of an inbound shipment to and an outbound shipment from one location, particularly a remote location, can offer cost savings. Another factor that affects costs is the length of a route. Carriers offer cheaper rates for longer hauls. By combining two short hauls together, a better rate can be achieved. Therefore, the evaluation of cost preferably considers the user's needs throughout its system when selecting a carrier for a particular lane.

### Communication System

A preferred system and method cooperates with a communication system to provide notification of shipping events. In particular, a preferred system and method sends a message to one or more pre-determined contacts to alert them to “exceptions”, i.e. that a scheduled event has not taken place according to the pre-determined plan. This alerting process allows managers to intercede to resolve problems as soon as they occur. The communication system can also provide alerts when activities have transpired according to plan. Preferably, the communication system cooperates with phone, fax, email, PDAs, and pager systems and does not require communication via a dedicated transmission path, such as a web site. Further, a preferred communication system provides alerts of varying degrees of severity. Using these escalating alerts, a manager can be apprised if an exception, for which the system has previously provided an alert, is not being resolved. The integration of a communication system with the per-lane system and method for assigning carriers offers advantage.

Although an illustrative version of the device is shown, it should be clear that many modifications to the device may be made without departing from the scope of the invention.

What is claimed is:

1. A method of selecting a carrier from a group of carriers to make a trip to transport goods from a first location to a second location, comprising the steps of:
a) evaluating each carrier's past performance on previously-made trips from the first location to the second location;
b) comparing the carriers based on their past performances on trips from the first location to the second location; and
c) selecting a carrier.

2. A method of selecting a carrier from a group of carriers to transport goods from a first location to a second location, according to claim 1, further comprising the step of:
d) evaluating each carrier's capacity to make trips between said first and second locations during a given time period; and
e) comparing the carriers based on their past performances on trips from the first location to the second location and on their capacity to make trips between said first and second locations during a given time period.

3. A method of selecting a carrier from a group of carriers to transport goods from a first location to a second location, according to claim 1; further comprising the step of:
d) evaluating the cost for each carrier to make the trip;
e) comparing the carriers based on their past performances on trips from the first location to the second location and on their cost to make trips between said first and second locations during a given time period.

4. A method of selecting a carrier from a group of carriers to transport goods from a first location to a second location, according to claim 2, further comprising the step of:
e) evaluating the cost for each carrier to make the trip;
f) comparing the carriers based on their past performances on trips from the first location to the second location, on their capacity to make trips between said first and second locations during a given time period, and on the cost for each carrier to make the trip.

5. A method according to claim 1 further comprising the step of:
d) after a carrier is selected to transport goods from a first location to a second location, adjusting the carrier's capacity data to reflect that load taken.

6. A method according to claim 5, further comprising the steps of:
e) storing carrier capacity data based on contractual requirements and limits in a database in association with the carrier;
f) updating said capacity data upon carrier's acceptance of a trip.

7. A method according to claim 6, wherein the contractual requirements and limits are for a specified time period, and further comprising the step of:
g) resetting the stored carrier capacity data upon completion of a specified time period.

8. A method according to claim 1, further comprising the steps of:
d) determining the mode of each load for a specified trip between the first location and the second location; and
e) comparing the carriers based on their past performances on trips from the first location to the second location and on mode to make a trip between said first and second locations during a given time period.

9. A method according to claim 1, wherein said past performance is evaluated based on on-time percentage.

10. A method according to claim 1, wherein said past performance is evaluated based on claims ratio.

11. A method according to claim 1, wherein said past performance is evaluated based on on-time percentage and claims ratios.

12. A method of selecting a carrier from a group of carriers to make a trip to transport goods from a first location to a second location during a given time period, comprising the steps of:
a) evaluating each carrier's capacity to make trips between said first and second locations during a given time period;
b) comparing the carriers based on their capacity to make a trip from the first location to the second location during the given time period; and
c) selecting a carrier.

13. A method of selecting a carrier from a group of carriers to transport goods from a first location to a second location, according to claim 12, further comprising the step of:
d) evaluating each carrier's past performance on trips between said first and second locations; and
e) comparing the carriers based on their past performances on trips from the first location to the second location and on their capacity to make trips between said first and second locations during a given time period.

14. A method of selecting a carrier from a group of carriers to transport goods from a first location to a second location, according to claim 12; further comprising the step of:
d) evaluating the cost for each carrier to make the trip;
e) comparing the carriers based on their capacity for trips from the first location to the second location during a given time period and on their cost to make trips between said first and second locations during a given time period.

15. A method of selecting a carrier from a group of carriers to transport goods from a first location to a second location, according to claim 13, further comprising the step of:
e) evaluating the cost for each carrier to make the trip;
f) comparing the carriers based on their past performances on trips from the first location to the second location, on their capacity to make trips between said first and second locations during a given time period, and on the cost for each carrier to make the trip.

16. A method according to claim 12 further comprising the step of:
d) after a carrier is selected to transport goods from a first location to a second location, adjusting the carrier's capacity data to reflect that load taken.

17. A method according to claim 12, further comprising the steps of:
e) storing carrier capacity data based on contractual requirements and limits in a database in association with the carrier;
f) updating said capacity data upon carrier's acceptance of a trip.

18. A method according to claim 17, wherein the contractual requirements and limits are for a specified time period, and further comprising the step of:
g) resetting the stored carrier capacity data upon completion of a specified time period.

19. A method according to claim 12, further comprising the steps of:
d) determining the mode of each load for a specified trip between the first location and the second location; and
e) comparing the carriers based on their capacity on trips from the first location to the second location during a given time period and on their mode to make a trip between said first and second locations during a given time period.

20. A method of selecting a carrier from a group of carriers to transport a shipment of goods from a first location to a second location, comprising the steps of:
a) for each carrier, identifying the maximum number of shipments allowed to that carrier over a given period of time;
b) comparing the number of shipments carried by each carrier during the given period to the maximum number allowed to that carrier;
c) for each carrier that has not exceeded the allowed shipment number during said period:
(i) evaluating each carrier's past performance on trips from the first location to the second location;
ii) evaluating each carrier's capacity;
iii) evaluating the cost for each carrier to make the trip;
iv) comparing the carriers;
v) selecting a carrier; and
vi) adjusting the capacity data of the selected carrier for the given period.
